(19) United States
(12) Patent Application Publication
(10) Pub. No.: US 2008/0196841 A1
(43) Pub. Date: Aug. 21, 2008

(54) WATER-BASED PRECIPITATION OF POLYMER SOLUTIONS

(75) Inventors: Frederick L. Coan, Antioch, CA (US); Arthur J. Barajas, Oakley, CA (US)

Correspondence Address: WILLIAM H. EILBERG, THREE BALA PLAZA, SUITE 501 WEST, BALA CYNWYD, PA, 19004, US

(73) Assignee: GENERON IGS, INC., Houston, TX (US)

(21) Appl. No.: 12/030,296

(22) Filed: Feb. 13, 2008

Related U.S. Application Data
(60) Provisional application No. 60/890,347, filed on Feb. 16, 2007.

(51) Int. Cl. B01D 1/00

(52) U.S. Cl. 159/47.1

(57) ABSTRACT

A solid polymer is recovered from a solution by the addition of a water-based solution containing a surfactant. The solutions are mixed and heated, so that the organic solvent containing the polymer is driven off, and the solid polymer can be recovered. The solid polymer is generally recovered in the form of small particles, which can be easily moved, as part of a slurry, and then dried. The process produces no hazardous waste. The by-products of the process can be re-used or discarded through ordinary channels.

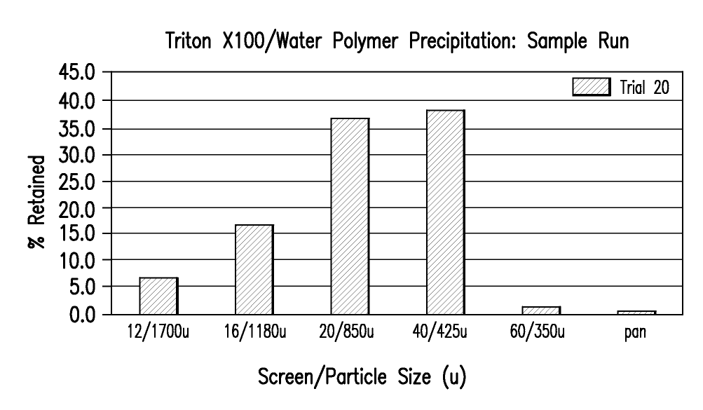

### CROSS-REFERENCE TO PRIOR APPLICATION

Priority is claimed from U.S. provisional patent application Ser. No. 60/890,347, filed Feb. 16, 2007, the entire disclosure of which is incorporated by reference.

### BACKGROUND OF THE INVENTION

The present invention relates to the field of extracting solid polymeric materials from solutions.

Polymeric materials are typically provided in solutions containing organic solvents. For example, a polymer such as a polycarbonate may be provided in a solution of methylene chloride. In the prior art, the polymer has been removed from the solution by mixing the solution with another organic solvent, such as ethanol or methanol, which mixes freely with the original solvent (methylene chloride, in the above example). As the amount of the second solvent increases, the polymer precipitates out of the solution.

The method described above has at least the following disadvantages:

1. The additional organic solvent, such as ethanol or methanol, must be added in a relatively large quantity, of the order of 40% by weight, in order to cause the polymer to precipitate out of solution. This requirement increases the cost of the processes of the prior art.

2. After the polymer has precipitated out of the solution, there remain two organic solvents, mixed together, which must either be handled as hazardous waste, or which must be distilled to separate and re-use them.

3. The process described above tends to produce relatively large, non-uniformly shaped polymeric particles. Such particles, which may have the form of randomly shaped flakes, are often so large as to clog ports in the equipment. They are also difficult to dry.

It has also been known to use aqueous means for precipitating a polymer from its solution. In particular, it has been known, in the prior art, to treat a polymer solution with steam, to cause the solid polymeric material to come out of solution. Such processes are described in U.S. Pat. Nos. 4,212,967 and 4,568,418, the disclosures of which are hereby incorporated by reference. But a steam-based process has various disadvantages. The cost of producing and handling steam obviously adds significantly to the cost of producing the polymer. A steam-based process also suffers from the disadvantage that the polymeric particles produced tend to be large and randomly shaped.

The present invention provides an improved process for producing a solid polymeric material, wherein the process overcomes the problems described above. The process of the present invention produces polymeric material at a substantially lower cost, compared to processes of the prior art.

### SUMMARY OF THE INVENTION

The present invention comprises a process wherein a solid polymer is recovered from a solution by the steps of adding a water-based solution containing a surfactant, and heating and mixing the solutions. The heating causes the organic solvent carrying the polymer to evaporate, and the polymer precipitates from the mixture. The polymeric material can then be filtered and dried.

In one embodiment, the polymer can be TBBA polycarbonate, in a solution of methylene chloride. The surfactant can be Triton X 100, also known as octyl phenol ethoxylate. The invention is not limited to the specific polymer, solvent, or surfactant stated above.

The process of the present invention tends to produce polymeric particles which are relatively small and relatively uniform in size. The size of the particles can be controlled by controlling at least one of 1) the ratio of polymer solution to precipitation solution, 2) the loading of solids in the polymer solution, and 3) the speed of the mixing.

The invention therefore has the primary object of providing a method for recovering solid polymeric material-from a solution.

The invention has the further object of eliminating the need for an organic precipitation solution for recovery of a polymer.

The invention has the further object of reducing the cost of recovering a polymer from an organic solution.

The invention has the further object of providing a process for recovering a polymer from an organic solution, wherein the process does not generate hazardous waste.

The reader skilled in the art will recognize other objects and advantages of the present invention, from a reading of the following brief description of the drawing, the detailed description of the invention, and the appended claims.

### BRIEF DESCRIPTION OF THE DRAWING

The FIGURE provides a graph showing the distribution of polymeric particle sizes produced by the process of the present invention.

### DETAILED DESCRIPTION OF THE INVENTION

The present invention comprises a process for recovery of a polymer, from a polymer-solvent solution, by mixing the polymer solution with a precipitation solution including water and a surfactant or detergent, and heating the mixture.

An important aspect of the present invention is the use of a non-steam, aqueous solution, rather than an organic solution, to recover the polymer. The use of water alone is insufficient, because it does not mix well with an organic solvent, and thus will not easily reach the polymer. But the water-surfactant solution essentially converts the mixture of the polymer solution and precipitation solution into the equivalent of a single-phase solution, allowing intimate contact between the water and the polymer.

The basic process of the present invention is practiced in a precipitation vessel equipped with a high-shear mixer. A solution of water and a surfactant is first added to the precipitation vessel, and the mixer is started. Then, a solution containing a polymer and an organic solvent is added to the vessel, and the speed of the mixer is increased. Then, while the mixing continues, the contents of the vessel are gradually heated such that the temperature of the mixture rises to about 10-15° C. greater than the boiling point of the organic solvent. When the solvent has been completely evaporated, the heat is removed, and the water-surfactant solution is decanted off. The polymeric solids can then be filtered to remove all of the water. The solids may be further washed to remove residual surfactant, before being dried.

A high-shear mixer is used, in the present invention, so as to disperse uniformly the organic and aqueous phases prior to, and during, the heating step.

The water-surfactant solution preferably contains about 0.25% to about 3%, by weight, of surfactant, a preferred amount being about 1%. This is considerably less than the quantities of organic precipitation solvent typically required in the prior art.

The precipitation vessel preferably has a hemispherical or rounded bottom. The reason for this structure is that a tank having a flat bottom has corners in which polymeric material may accumulate, and from which it is difficult to remove the polymer.

One preferred precipitation vessel has a ratio of height to diameter (H/D) of about 3:1. The amount of water required is determined by the polymer solids loading. A loading of 10% solids, by weight, requires a water/polymer-solution ratio of 2:1, by weight. A polymer solution having a loading of 20% solids requires a water/polymer-solution ratio of 4:1. For example, 500 grams of a polymer solution having 10% solids, by weight, would require 1000 grams of the 1% surfactant-water solution, while 500 grams of a polymer solution having 20% solids, by weight, would require 2000 grams of the 1% surfactant-water solution. The invention is not limited to vessels having the dimensions described above, or to a particular loading of polymer solids.

When the mixer is first started, a preferred starting tip speed is about 104 meters per minute, to minimize foaming due to the surfactant. The polymer solution is preferably added after a delay of about 30-45 seconds, and the tip speed is then increased to about 205 meters per minute. The heat is applied, and the temperature is ramped up to the final set point during a period of about 30-45 minutes. In the case where the organic solvent is methylene chloride, the solution would be heated until it reaches about 55° C.

It may be necessary to hold the temperature at the final set point so as to remove the solvent fully. Removal of the solvent can be verified by stopping the mixer, allowing the polymer solids to settle to the bottom, and watching for additional bubbling coming from the polymer particles. The absence of bubbling indicates that the organic solvent has been substantially removed.

The size of the polymeric particles produced can be controlled by 1) the ratio of polymer solution to precipitation solution, 2) the solids loading in the polymer solution, and 3) the mixing heat tip speed. Depending on the particle size desired and the process economics, additional grinding may be required.

It is an advantage of the present invention that it produces small particles, which are easy to dry, and which comprise a flowable material. Without the use of the surfactant, the particles would become so large that it would be difficult to move the particles out of the vessel. With small particles, the wet polymer can take the form of a slurry which can be easily moved and filtered. With the present invention, the particles tend to be more spherical than those produced by prior art methods.

### EXAMPLE

A precipitation vessel was provided with a high-shear mixer manufactured by Admix, under Model No. OPLB 250. The mixer had an impeller capable of speeds of up to 10000 RPM. The impeller had a diameter of 3.18 cm. The vessel was made of Pyrex, and had a round bottom with a capacity of four liters. The height of the vessel was 34.3 cm and its diameter was 12.7 cm, giving a ratio H/D of about 2.7. Heat was provided by an electric heater.

The polymer being recovered was tetro bromo bisphenol-A (TBBA) polycarbonate. The polymer was provided in a solution of methylene chloride. The polymer solution was available in a concentration in a range of about 10-20% by weight.

The water used was water that had been at least partially deionized by reverse osmosis.

The surfactant used was the material sold by Aldrich Chemical, under the designation Triton X 100 (having CAS No. 9002-93-1), and also known as octyl phenol ethoxylate.

The vertical position of the impeller head was set at about 1.9 cm above the bottom of the vessel. The horizontal position of the head was set to be about 2.2 cm from the interior wall of the vessel.

The polymer solution was provided in the amount of 502 grams, which translated to about 20%, by weight, of TBBA-polycarbonate in methylene chloride. The precipitation solution contained 1998 grams (1% by weight) of Triton X 100, in reverse-osmosis water.

The process was begun with the temperature of the surfactant solution at 20° C., and the mixer at 4000 RPM.

The following table describes the process as conducted, at each of several time points:

| Time | Event |
|---|---|
| 1-2 min. | The polymer solution was added; RPM set to 7500. |
| 2.5 min. | The addition of polymer solution was complete. |
| | The electric heater was activated, at a setting |
| | intended to yield a temperature of about 40-45° C. |
| 12 min. | The temperature was 25° C.; the RPM set to 7525. |
| 18 min. | The temperature was 33° C.; the RPM was 7515. |
| | Some polymer material was observed to come |
| | out of solution. |
| 20 min. | The temperature was 35° C.; the RPM was set to 8000. |
| | Chunks of solid polymer were observed to form. |
| 22 min. | The heater control was set to produce a temperature |
| | of about 45-55° C. |
| 23 min. | The RPM was set to 8100. The solution was observed |
| | to change from a fairly uniformly cloudy solution |
| | to a mixture of cloudy regions and clear regions, |
| | triggered by the loss of the organic phase, i.e. |
| | the methylene chloride that was evaporating. |
| 29 min. | The RPM was set to 9000; polymer material, which |
| | had accumulated on the inside wall of the vessel, |
| | was observed to begin to slough off. |
| 31 min. | The temperature was 45° C.; the inside wall of the |
| | vessel was observed to be free of polymer, as all |
| | such material had come off. |
| 32 min. | The RPM was reduced to 8000. |
| 33 min. | The temperature was 47° C. |
| 35 min. | The temperature was 50° C. Agitation was stopped. |
| | Bubbling was observed to come from beads of polymer |
| | material at the bottom of the vessel, indicating |
| | that the methylene chloride had not yet been fully |
| | removed. |
| 36 min. | The temperature was 54° C. Agitation was restarted |
| | at 2500 RPM to remove the methylene chloride. |
| 40 min. | The process was stopped. The liquid was decanted, |
| | and the polymer beads were filtered out. |

The residual liquid weighed 1906 grams, and was cloudy in appearance. The amount of liquid used initially was 1978 grams of water, plus 20 grams of Triton X 100, for a total of 1998 grams. The amount of material loss was therefore (1−(1906/1998))*100=4.6%.

The FIGURE provides a histogram showing the distribution of particle sizes produced by the above-described process. The abscissa is labeled with standard screen sizes (namely 12, 16, 20, 40, 60), and by the particle size. The ordinate, labeled “% Retained”, represents the proportion of retained material for each size.

The FIGURE therefore shows that most of the particles had a size in the range of 425-850 microns. Such particles are sufficiently small to form a flowable material, and sufficiently small to be easily dried.

The present invention has the following advantages over the prior art.

1. The present invention avoids the need for precipitation solvents, such as ethanol or methanol. Not only must such precipitation solvents be used in a relatively large amount to be effective (of the order of about 40% by weight), but they must then be recovered through distillation or treated as hazardous waste for disposal.

2. The present invention uses the surfactant in very small quantities, of the order of about 1% by weight. Since the organic solvent holding the polymer is removed by the heating step, the precipitation solution, comprising water and surfactant, can be re-used a number of times, thereby reducing the amount of waste generated. This water-surfactant solution is sufficiently innocuous that it can be processed by a public water treatment facility, and need not be treated as hazardous waste.

3. The heating step also removes the organic solvent from the solid polymer and the water-surfactant solution, enabling the organic solvent to be recovered for subsequent disposal or for recycling.

4. Removal of the organic solvent, by the process of the present invention, reduces or eliminates the possibility that the precipitated polymer will re-agglomerate, and thus makes it easier, and safer, to conduct the final steps of recovering the solid polymer and drying it.

5. The present invention eliminates the need for a continuous system for feeding the water and surfactant solution. Thus, the process of the present invention does not require special equipment to control the rate at which the water/surfactant solution is added to the vessel. The water/surfactant and polymer solutions are added to the vessel in a batch-wise manner.

6. The process of the invention produces particles that can be easily dried and used directly, without further grinding. Prior art methods, such as steam precipitation, generally produce larger particles that are difficult to dry, and which require further grinding.

The invention can be modified in various ways. The invention is not limited to use with the materials stated in the examples given above, but can be practiced with various polymers, solvents, and surfactants. Such modifications, which will be apparent to those skilled in the art, should be considered within the spirit and scope of the following claims.

What is claimed is:

1. A process for recovering a polymeric material from a solution containing polymeric material, the process comprising:
a) mixing a solution containing a polymeric material with an aqueous solution containing a surfactant, to form a mixture,
b) heating the mixture, and
c) recovering precipitated solid polymeric material.

2. The process of claim 1, wherein the solution containing the polymeric material includes an organic solvent, and wherein step (b) comprises heating the mixture to a temperature sufficient to drive off the organic solvent.

3. The process of claim 2, comprising heating the mixture to a temperature which is at least about 10° C. greater than a boiling point of the organic solvent.

4. The process of claim 2, wherein the organic solvent comprises methylene chloride.

5. The process of claim 1, further comprising selecting the polymeric material to be tetro bromo bisphenol-A (TBBA) polycarbonate.

6. The process of claim 4, further comprising selecting the polymeric material to be tetro bromo bisphenol-A (TBBA) polycarbonate.

7. The process of claim 1, wherein step (c) comprises decanting the solution containing the surfactant, and filtering precipitated polymeric solids.

8. The process of claim 1, further comprising selecting the surfactant to be octyl phenol ethoxylate.

9. The process of claim 1, further comprising controlling a size of polymeric particles produced, by controlling at least one of 1) a ratio of polymer solution to precipitation solution, 2) a loading of solids in the polymer solution, and 3) a speed of the mixing of step (a).

10. The process of claim 1, wherein the surfactant is present in the aqueous solution in a concentration in a range of about 0.25-3%, by weight.

11. A process for recovering polymeric material from a solution containing polymeric material, comprising:
a) forming a first solution comprising a surfactant and water, and mixing said first solution,
b) adding, to said first solution, a second solution containing a polymer and an organic solvent, said first and second solutions forming a mixture,
c) heating said mixture such that a temperature of the mixture increases above a boiling point of the organic solvent, the heating step being performed such that the organic solvent evaporates from the mixture,
d) removing at least some of the first solution, and
e) recovering solid polymeric material.

12. The process of claim 11, wherein step (a) includes the step of selecting the surfactant to be octyl phenol ethoxylate.

13. The process of claim 11, wherein step (c) comprises heating said mixture to a temperature at least 10° C. greater than a boiling point of said organic solvent.

14. The process of claim 11, wherein step (d) comprises decanting said first solution from the mixture.

15. The process of claim 11, wherein step (e) includes filtering the polymeric material so as to remove water therefrom.

16. The process of claim 11, wherein said first solution is selected to contain surfactant in a range of about 0.25% to about 3%, by weight.
